(19) United States
(12) Patent Application Publication
(10) Pub. No.: US 2026/0044848 A1
(43) Pub. Date: Feb. 12, 2026

(54) METHOD AND SYSTEM FOR ENCRYPTED DIGITAL NOTE GENERATION AND TRANSFER

(71) Applicant: Mehdi Frederik Soltan, Hong Kong (HK)

(72) Inventor: Mehdi Frederik Soltan, Hong Kong (HK)

(73) Assignee: hamid Fahimi, mountain view, CA (US)

(21) Appl. No.: 19/362,391

(22) Filed: Oct. 18, 2025

Related U.S. Application Data
(62) Division of application No. 18/069,999, filed on Dec. 21, 2022.

(51) Int. Cl. G06Q 20/36; G06Q 20/38

(52) U.S. Cl. CPC G06Q 20/3674; G06Q 20/38215; G06Q 20/3829

(57) ABSTRACT

A digital note includes a note ID, a crypto currency wallet address, a crypto currency amount, and an encrypted digital note (EDN) associated with the digital note. The EDN includes the note ID, the crypto currency wallet address, the crypto currency amount, and a crypto currency wallet private key or a portion of the crypto currency wallet private key that are encrypted together.

### CROSS-REFERENCE TO RELATED APPLICATIONS

This application is a Divisional of U.S. patent application Ser. No. 18,069,999 filed on Dec. 21, 2022, the entire disclosure of which is incorporated herein by reference.

### BACKGROUND

Transferring a crypto currency for payments related to daily shopping through the blockchain is with delay and is costly. It is highly desirable to define a cheaper and faster method for transferring the crypto currency.

### BRIEF DESCRIPTION OF THE DRAWING

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIGS. 1A, 1B, and 1C respectively illustrate a digital note, an encrypted digital note (EDN), and a digital collateral, in accordance with some embodiments of the disclosure.

FIGS. 2A and 2B respectively illustrate a digital note/collateral server and a user device requesting the generation of a digital note or digital collateral, in accordance with some embodiments of the disclosure.

FIGS. 3A and 3B respectively illustrate a digital note/collateral server and multiple user devices for transferring digital notes between the multiple user devices, in accordance with some embodiments of the disclosure.

FIGS. 4A, 4B, and 4C illustrate flow diagrams of processes for generating a digital note and a digital collateral, in accordance with some embodiments of the disclosure.

FIGS. 5A and 5B illustrate flow diagrams of processes for transferring a digital note and a digital collateral, in accordance with some embodiments of the disclosure.

FIG. 6 illustrates a diagram of a computer module.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. In addition, the term “being made of” may mean either “comprising” or “consisting of” In the present disclosure, a phrase “one of A, B and C” means “A, B and/or C” (A, B, C, A and B, A and C, B and C, or A, B and C), and does not mean one element from A, one element from B and one element from C, unless otherwise described.

When a crypto currency is transferred via the blockchain, it takes some time, e.g., between few minutes and up to few hours, and the transfer of the crypto currency is expensive, e.g., a few cents to few dollars per transaction. A different method is suggested that wraps a crypto currency wallet, e.g., a crypto wallet, in digital note and transfers the digital note using another server.

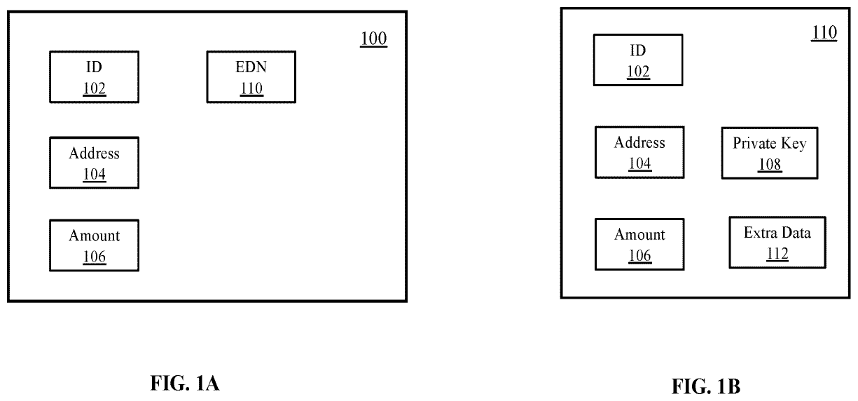

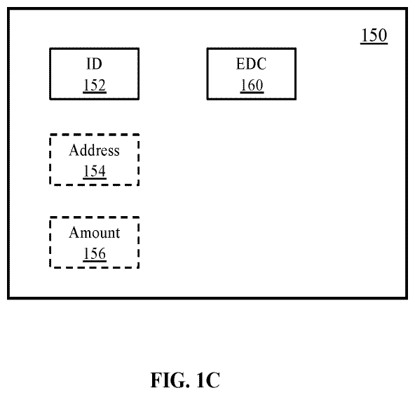

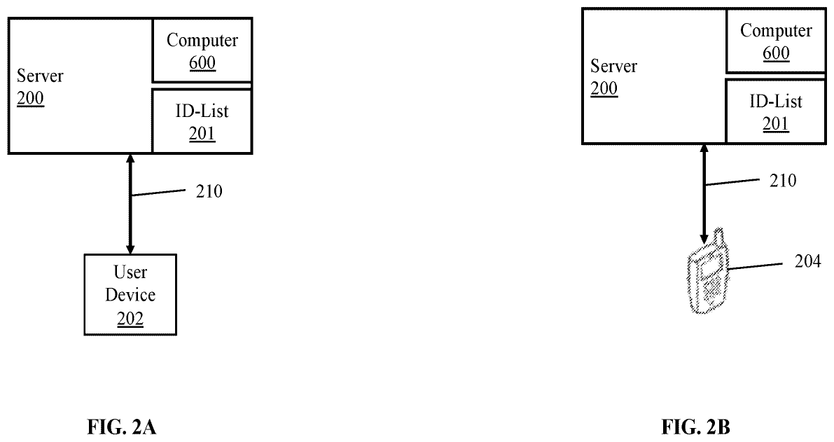

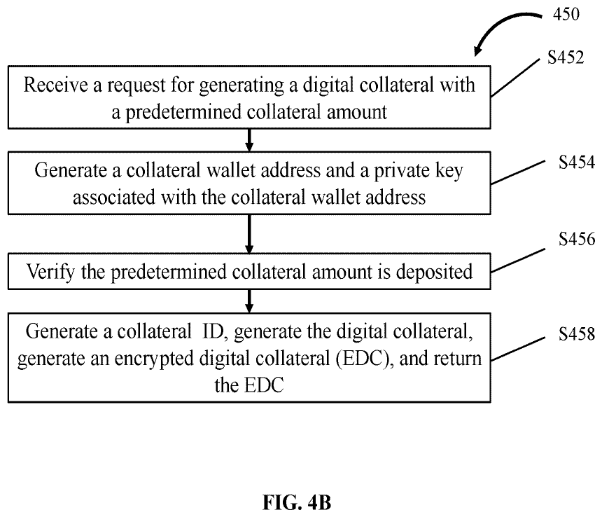

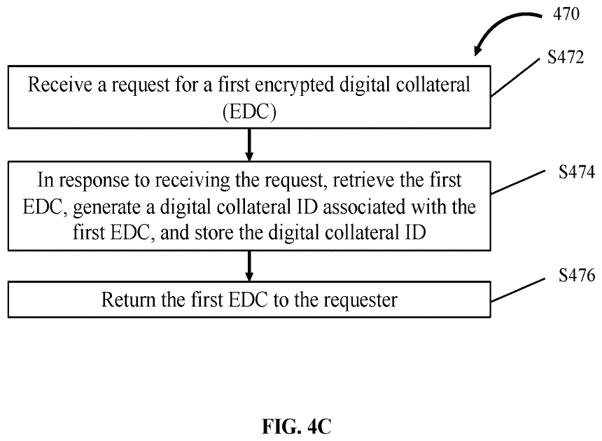

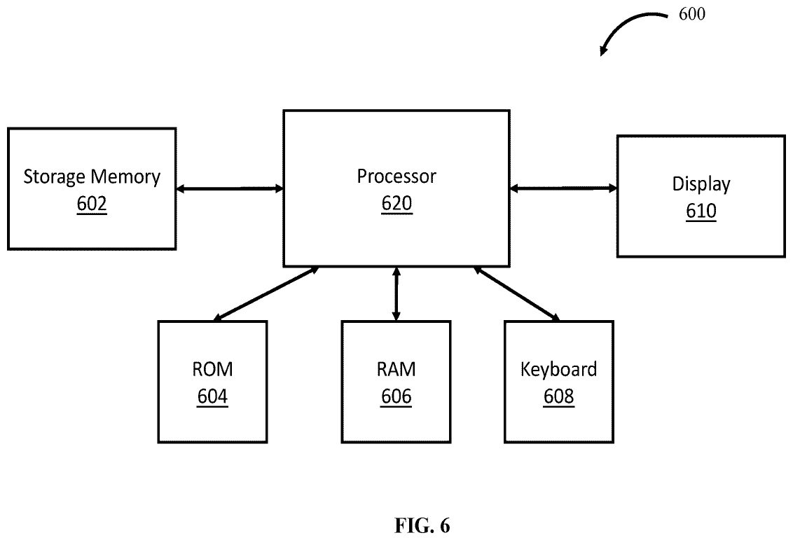

FIGS. 1A, 1B, and 1C respectively illustrate a digital note 100, an encrypted digital note (EDN) 110, and a digital collateral 150, in accordance with some embodiments of the disclosure. The digital note 100 includes a note ID 102, e.g., a note ID, a crypto currency wallet address 104 (an address of the crypto currency wallet, e.g., a public key of the crypto currency wallet), and a crypto currency amount 106. The digital note further includes the EDN 110. In some embodiments, the crypto currency wallet address 104 is a public key of the crypto currency. FIG. 1B illustrates the EDN 110 that includes a combination of the note ID 102, the crypto currency wallet address 104, the crypto currency amount 106, and a crypto currency wallet private key 108 that is being encrypted. The crypto currency wallet private key 108 is a private key of the crypto currency wallet associated with the public key of the crypto currency wallet. Generating the digital note 100 is described with respect to FIG. 4A. In some embodiments, an entire crypto currency wallet private key 108 is stored in the digital note 100. In some embodiments, only a portion of the crypto currency wallet private key 108 is stored in the digital note 100. In some embodiments, the EDN 110 additionally includes extra data 112 that includes one or more of a predetermined physical address, a predetermined date, a predetermined proper name, a predetermined quote, etc. The extra data 112 is encrypted along with data of the note ID 102, the crypto currency wallet address 104, and the crypto currency amount 106. The encryption is described with respect to FIGS. 2A, 2B, and 6. In some embodiments, the crypto currency is a Bitcoin, an Ether of Ethereum, or etc.

FIG. 1C shows the digital collateral 150 that includes an ID, e.g., a digital collateral ID 152. In some embodiments, the digital collateral 150 also includes an address, e.g., a serial number of the digital collateral 154, which is a public key of a collateral wallet. In some embodiments, the digital collateral 150 further includes a value, e.g., an amount of the digital collateral 156. In some embodiments, the digital collateral 150 includes an encrypted digital collateral (EDC 160) that is generated by encrypting a combination of the digital collateral ID 152, the serial number of the digital collateral 154, and the amount of the digital collateral 156. In some embodiments, extra data is incorporated when the EDC 160 is generated. In some embodiments, the digital collateral 150 does not include the amount of the digital collateral 156 or the serial number of the digital collateral 154 but the EDC 160 includes the include the amount of the digital collateral 156 or the serial number of the digital collateral 154. In some embodiments, as noted, the serial number of the digital collateral 154 is the public key of the digital wallet. In some embodiments, in addition to the serial number of the digital collateral 154, the EDC 160 includes either an entire or a portion of a private key associated with the serial number of the digital collateral 154. In some embodiments, the digital collateral 150 only includes the digital collateral ID 152 and the EDC 160. In some embodiments, the digital collateral 150 only includes the EDC 160. In some embodiments, the digital collateral 150 does not include a wallet.

FIGS. 2A and 2B respectively illustrate a digital note/collateral server and a user device requesting the generation of a digital note or a digital collateral, in accordance with some embodiments of the disclosure. FIG. 2A shows a user device 202 in communication link 210 with a digital note/collateral server 200. In some embodiments, the user device 202 sends a request to the digital note/collateral server 200 to generate a digital note 100. In response the digital note/collateral server 200 generates a digital note, e.g., the digital note 100 and sends the digital note 100 to the user device 202. In some embodiments, the digital note/collateral server 200 generates the public key and private key pair for the crypto currency wallet and, also, generates the note ID 102 for the digital note 100 and stores the note ID 102 in a valid ID-list 201, a list of valid IDs, in a memory of the digital note/collateral server 200.

Alternatively, FIG. 2A shows that the user device 202 sends a request to the digital note/collateral server 200 to generate a digital collateral 150. In response the digital note/collateral server 200 generates a digital collateral, e.g., the digital collateral 150 and sends the digital collateral 150 to the user device 202. In some embodiments, the digital note/collateral server 200 generates the public key and private key pair for a collateral wallet and, also, generates the digital collateral ID 152 for the digital collateral 150 and stores the digital collateral ID 152 in a valid ID-list 201, e.g., a list of valid IDs, in a memory of the digital note/collateral server 200. In some embodiments, the public key and private key pair are associated with the collateral wallet. In some embodiments, the digital note/collateral server 200 is either only a digital note server or only a digital collateral server.

FIG. 2B is similar to FIG. 2A but instead of the user device 202, a mobile device 204 is in communication link 210 with the digital note/collateral server 200. In some embodiments, the mobile device 204 sends a request to the digital note/collateral server 200 to generate the crypto currency wallet and the digital note/collateral server 200 generates the note ID 102, the public key, and the associated private for the crypto currency. The digital note/collateral server 200 further encrypts together the note ID 102, the crypto currency wallet address 104, the crypto currency amount 106, and the crypto currency wallet private key 108 and generates the EDN 110. Thus, the digital note/collateral server 200 generates the EDN 110 and sends the EDN 110 to mobile device 204. In some embodiments, the encryption is performed by a computer module 600 of the digital note/collateral server 200 and the valid ID-list 201 is stored in a storage memory of the computer module 600. The computer module 600 is described with respect to FIG. 6.

Alternatively, FIG. 2B shows that the mobile device 204 sends a request to the digital note/collateral server 200 to generate the collateral wallet and the digital note/collateral server 200 generates the digital collateral ID 152, the public key of the collateral wallet, and the associated private key of the collateral wallet. The digital note/collateral server 200 further encrypts together the digital collateral ID 152, the serial number of the digital collateral 154, the amount of the digital collateral 156, and the private key of the collateral wallet and generates the EDC 160. Thus, the digital note/collateral server 200 generates the EDC 160 and sends the EDC 160 to mobile device 204. In some embodiments, the digital note/collateral server 200 does not generate the EDC 160 and receives the EDC 160 from an issuing authority (e.g., an external source) and transfers the EDC 160 to the mobile device 204. Thus, as described above, the digital collateral 150 may only include the EDC 160. In some embodiments, the encryption is performed by a computer module 600 of the digital note/collateral server 200 and the valid ID-list 201 is stored in a storage memory of the computer module 600. The computer module 600 is described with respect to FIG. 6. In some embodiments, the EDC 160 is an encrypted deed of a property, e.g., a house or a car, which is received by the digital note/collateral server 200 from a corresponding issuing authority. In some embodiments, the computer module 600 and/or the processor 620 is coupled to and in communication with an external source and receives data from the external source and stores the received data in the storage memory 602. In some embodiments, the computer module 600 receives encrypted data, e.g., one or more EDCs 160, from the external source and the one or more EDCs 160 are not accessible by the computer module 600.

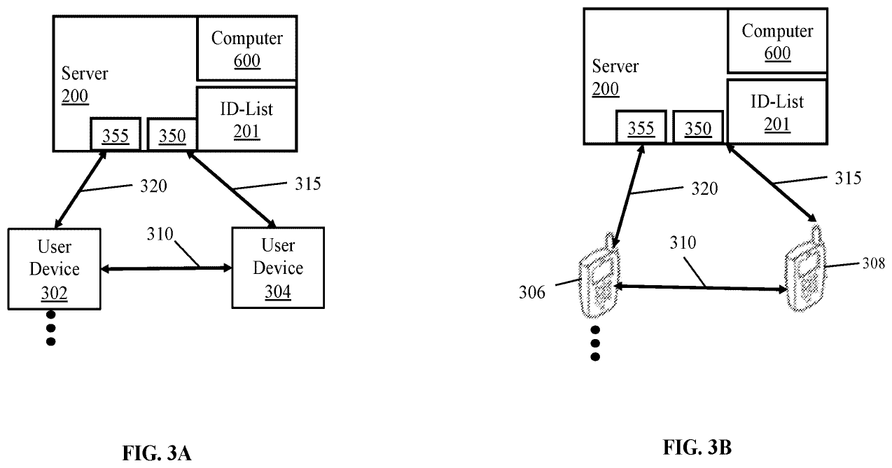

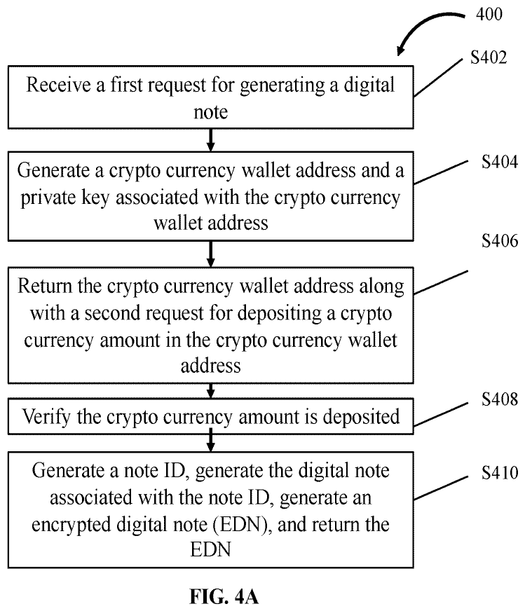

FIGS. 3A and 3B respectively illustrate a digital note/collateral server 200 and multiple user devices for transferring digital notes between the multiple user devices, in accordance with some embodiments of the disclosure. FIG. 3A shows a user device 304 that is in communication, via a communication link 315, with the digital note/collateral server 200. The user device 304 is also in communication, via a communication link 310, with one or more user devices 302. In some embodiments, the user device 304 sends a transfer request and a first encrypted digital note of a first digital note, e.g., the EDN 110 of the digital note 100, through the communication link 315 to the digital note/collateral server 200 indicating request for transferring the digital note 100. In response to the request, the digital note/collateral server 200 generates a new EDN 110 based on the received EDN 110, removes the note ID 102 of the received EDN 110 from the valid ID-list 201, and stores a new note ID 102 of the new EDN 110 in the valid ID-list 201. The digital note/collateral server 200 further generates a transfer note based on the new EDN 110 and encrypts the transfer note sends an encrypted transfer note 350 to the user device 304. In some embodiments, the transfer note is encrypted by the computer module 600 of the digital note/collateral server 200 and, thus, the user device 304 may not have access to the new note ID 102 of the new EDN 110.

In some embodiments, the user device 304 sends the encrypted transfer note 350 via the communication link 310 to a user device 302. In some embodiments, the communication link 310 is the Internet and the user devices 304 sends the encrypted transfer note 350 through the Internet to the user device 302. In some embodiments, the user device 304 and the user device 302 are physically close, e.g., not farther than about 2 meters, and the user device 304 and the user device 302 use sound communication the communication link 310 implements sound wave between the user device 304 and the user device 302. In some embodiments, the communication link 315 and the communication link 320 are via the Internet. In some embodiments, the steps described above are repeated and another encrypted transfer note 350 is sent to another user device 302. In some embodiments, after receiving the encrypted transfer note 350, the user device 302 sends the encrypted transfer note 350, via a communication link 320, to the digital note/collateral server 200 and the digital note/collateral server 200 generates a new digital note 100 based on the transfer note and sends the new digital note 100 to the user device 302. Thus, in response to receiving the transfer request the user device 304 loses access to the crypto currency. Also, after the transfer is completed and the digital note/collateral server 200 generates the new digital note 100, user device 302 gains access to the new digital note 100.

FIG. 3B is similar to FIG. 3A but instead of the user devices 302 and the user device 304, mobile devices 306 and a mobile device 308 use the communication link 310 to communicate with each other and use the communication links 315 and 320 to communicate with the digital note/collateral server 200.

Alternatively, in some embodiments, the user device 304 or the mobile device 308 sends a transfer request and a first encrypted digital collateral of a first digital collateral, e.g., the EDC 160 of the digital collateral 150, through the communication link 315 to the digital note/collateral server 200 indicating request for transferring the digital collateral 150. In response to the request, the digital note/collateral server 200 generates a new EDC 160 based on the received EDC 160, removes the digital collateral ID 152 of the received EDC 160 from the valid ID-list 201, and stores a new digital collateral ID 152 of the new EDC 160 in the valid ID-list 201. The digital note/collateral server 200 further generates a transfer collateral that is encrypted, e.g., an encrypted transfer collateral 355 based on the new EDC 160 and sends the encrypted transfer collateral 355 to the user device 304 or the mobile device 308. In some embodiments, the transfer collateral 355 is encrypted by the computer module 600 of the digital note/collateral server 200 and, thus, the user device 304 may not have access to the new digital collateral ID 152 of the new EDC 160. In some embodiments, in addition to the note ID 102 or digital collateral ID 152, valid ID-list 201 stores a link to an associated digital note 100 or the digital collateral 150, or alternatively the valid ID-list 201 stores a link to an associated EDN 110 or stores a link to an associated EDC 160.

In some embodiments, the user device 304 sends the encrypted transfer note 350 or the encrypted transfer collateral 355 via the communication link 310 to a user device 302. In some embodiments, the communication link 310 is the Internet and the user devices 304 sends the encrypted transfer note 350 through the Internet to the user device 302. In some embodiments, the user device 304 and the user device 302 are physically close, e.g., not farther than about 2 meters, and the user device 304 and the user device 302 use sound communication the communication link 310 implements sound wave between the user device 304 and the user device 302. In some embodiments, the communication link 315 and the communication link 320 are via the Internet. In some embodiments, the steps described above are repeated and another encrypted transfer note 350 is sent to another user device 302. In some embodiments, after receiving the encrypted transfer note 350 or the encrypted transfer collateral 355, the user device 302 sends the encrypted transfer note 350 or the encrypted transfer collateral 355, via a communication link 320, to the digital note/collateral server 200 and the digital note/collateral server 200 generates a new digital note 100 or a new digital collateral 150 based on the encrypted transfer note 350 or the encrypted transfer collateral 355 and sends the new digital note 100 or the new digital collateral 150 to the user device 302. Thus, in response to receiving the transfer request the user device 304 loses access to the crypto currency or the digital collateral. Also, after the transfer is completed and the digital note/collateral server 200 generates the new digital note 100 or the new digital collateral 150, the user device 302 gains access to the new digital note 100 or the new digital collateral 150.

FIGS. 4A, 4B, and 4C illustrate flow diagrams of processes 400, 450, and 470 for generating a digital note and a digital collateral, in accordance with some embodiments of the disclosure. In some embodiments the processed 400 and 450 are performed by the digital note/collateral server 200 of FIGS. 2A and 2B. The process 400 of FIG. 4A is used for generating the digital note. In step S402, a request for generating a digital note 100 is received. In some embodiments, the request is received by the digital note/collateral server 200. In step S404, a crypto currency wallet address, e.g., a crypto currency wallet public key, and a crypto currency wallet private key associated with the crypto currency wallet public key is generated. In some embodiments, the crypto currency wallet public key and the crypto currency wallet private key are generated by the digital note/collateral server 200 and are stored by the computer module 600 of the digital note/collateral server 200 in a storage memory 602 of the computer module 600. In step S406, the crypto currency wallet address is returned. In some embodiments, as shown in FIGS. 2A and 2B, the request is generated by the user device 202 or the mobile device 204. Thus, in step S406, the crypto currency wallet address is returned to the user device 202 or the mobile device 204 along with a request by the digital note/collateral server 200 for the user device 202 or the mobile device 204 to deposit the crypto currency amount in, e.g., associated with, the wallet of the crypto currency. In step S408, the deposited crypto currency amount is verified. In some embodiments, the verification is performed by the digital note/collateral server 200. In step S410, a note ID is generated, and a digital note associated with the note ID is created, e.g., generated, and the encrypted digital note is returned. In some embodiments, as shown in FIGS. 2A and 2B, the note ID 102 is generated by the digital note/collateral server 200 and stored in the storage memory 602 of the computer module 600. Then, a digital note associated with the note ID 102 is created and is encrypted by the computer module 600 and the EDN 110 is returned by the digital note/collateral server 200 to the user device 202 or the mobile device 204.

The process 450 of FIG. 4B is used for generating digital collaterals. In step S452, a request for generating a digital collateral having a predetermined collateral amount is received. In some embodiments, the request is received by the digital note/collateral server 200. In step S454, a collateral serial number, e.g., a public key, and a private key associated with the public key is generated. In some embodiments, the public key and the private key are generated by the digital note/collateral server 200 and the public key and the private key are stored by the computer module 600 of the digital note/collateral server 200 in a storage memory 602 of the computer module 600. In step S456, the collateral amount of the digital collateral 150 is verified to be the predetermined collateral amount. In some embodiments, the verification is performed by the digital note/collateral server 200. In step S458, a collateral ID is generated, and a digital collateral associated with the collateral ID is created, e.g., generated, and the encrypted digital collateral (EDC) is returned. In some embodiments, as shown in FIGS. 2A and 2B, the collateral ID 102 is generated by the digital note/collateral server 200 and stored in the storage memory 602 of the computer module 600. Then, a digital collateral associated with the collateral ID 102 is created and is encrypted by the computer module 600 and the EDC 160, consistent with the EDN 110, is returned by the digital note/collateral server 200 to the user device 202 or the mobile device 204. Thus, in process 450, the digital collateral 150 is in a collateral wallet.

The process 470 of FIG. 4C is used for requesting and receiving an EDC from a server, e.g., the digital note/collateral server 200. In step S472, a request for a first EDC 160 is received. In some embodiments, the request is received by the digital note/collateral server 200. In some embodiments, the request is sent by the user device 202 or the mobile device 204 of FIGS. 2A and 2B. In step S474, in response to receiving the request, the first EDC 160 is retrieved. Also, a digital collateral ID 152 associated with the first EDC 160 is generated and the digital collateral ID 152 is stored. In some embodiments, the first EDC 160 is retrieved by the digital note/collateral server 200. In some embodiments, the digital note/collateral server 200 has received one or more EDC 160 from an issuing authority and has stored the received EDCs 160 in the storage memory 602. Thus, the digital note/collateral server 200 retrieves the first EDC 160 from the storage memory 602. In some embodiments, the digital note/collateral server 200 retrieves the first EDC 160 from the issuing authority. In some embodiments, the EDC 160 is an encrypted money order or travelers' check. In addition, the digital collateral ID 152 associated with the first EDC 160 is generated by the digital note/collateral server 200 and the digital collateral ID 152 is stored by the digital note/collateral server 200 in the storage memory 602.

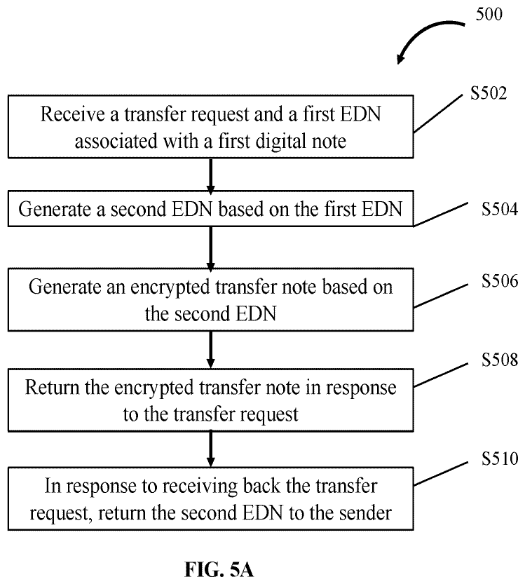

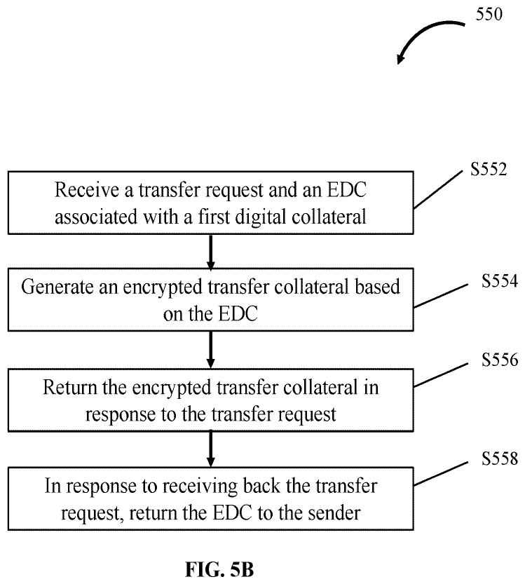

FIGS. 5A and 5B illustrate flow diagrams of processes 500 and 550 for transferring a digital note 100 and a digital collateral 150, in accordance with some embodiments of the disclosure. In some embodiments the processes 500 and 550 are performed by the digital note/collateral server 200 of FIGS. 3A and 3B. As shown in FIG. 5A, in step S502, a transfer request and a first encrypted digital note associated with a first digital note is received. In some embodiments, a transfer request for a crypto currency is received from the user device 304 or the mobile device 308, via the communication link 315, by the digital note/collateral server 200 of FIGS. 3A and 3B. The transfer request is received along with a first EDN 110 of a digital note 100. In step S504, a second EDN 110 is generated based on the first EDN 110. The second EDN 110 is generated, in response to the transfer request, by the digital note/collateral server 200. In step S506, an encrypted transfer note 350 is generated based on the second EDN 110. The encrypted transfer note 350 is generated by the digital note/collateral server 200. In step S508, the encrypted transfer note 350 is returned. In some embodiments, in response to the transfer request, the encrypted transfer note 350 is returned by the digital note/collateral server 200 to the user device 302 or the mobile device 308. In some embodiments, the second EDN 110 is generated by decrypting the first EDN 110 and then extracting the note ID 102, the crypto currency wallet address 104, the crypto currency amount 106, and the crypto currency wallet private key 108 of the first EDN 110. Next, generating a second note ID 102 by the digital note/collateral server 200, and generating the second EDN 110 using the second note ID 102 and the extracted crypto currency wallet address 104, the extracted crypto currency amount 106, and the extracted crypto currency wallet private key 108 of the first EDN 110. Also, the encrypted transfer note 350 is generated based on the second note ID 102, the extracted crypto currency wallet address 104, the extracted crypto currency amount 106, and the extracted crypto currency wallet private key 108 of the first EDN 110 and encrypting the second note ID 102, the extracted crypto currency wallet address 104, the extracted crypto currency amount 106, and the extracted crypto currency wallet private key 108 of the first EDN 110. In some embodiments, after generating the encrypted transfer note 350, the first note ID is removed from the list of valid ID-list 201 and the second note ID is added to the list of valid ID-list 201.

As shown in FIG. 5B, in step S552, a transfer request and an EDC 160 associated with a digital collateral 150 is received. In some embodiments, the transfer request is received from the user device 304 or the mobile device 308, via the communication link 315, by the digital note/collateral server 200 of FIGS. 3A and 3B. The transfer request is received along with the EDC 160 of the digital collateral 150. In step S554, an encrypted transfer collateral 355 is generated based on the EDC 160. The encrypted transfer collateral 355 is generated by the digital note/collateral server 200. In step S556, the encrypted transfer collateral 355 is returned to the requester. In some embodiments, in response to the transfer request, the encrypted transfer collateral 355 is returned by the digital note/collateral server 200 to the user device 302 or the mobile device 308. Also, the encrypted transfer collateral 355 is generated based on the EDC 160.

FIG. 6 illustrates a diagram of the computer module 600. The computer module 600 may be used in the digital note/collateral server 200, the user device 304, the user device 302, the mobile device 306, or the mobile device 308. The computer module 600 includes one or more processors 620, one or more storage memory 602, one or more read only memory (ROM 604), one or more random access memory (RAM 606), a keyboard or keypad 608, and a display screen 610. As described above, the valid ID-list 201 is stored and updated by the processor 620 in the storage memory 602.

As described above, by generating a digital note and transferring a crypto currency by the digital note, the crypto currency transaction becomes fast, e.g., between a fraction of a second up to a second and less expensive, e.g., about one cent per one hundred transactions.

According to some embodiments of the present disclosure, a digital note includes a note ID, a crypto currency wallet address, a crypto currency amount, and an encrypted digital note (EDN) associated with the digital note that includes the note ID, the crypto currency wallet address, the crypto currency amount, and a crypto currency wallet private key.

In some embodiments, the crypto currency wallet address is a public key of a crypto currency wallet associated with the digital note, and the crypto currency wallet private key is associated with the public key of the crypto currency wallet. In some embodiments, a crypto currency is either a Bitcoin or an Ether of Ethereum. In some embodiments, the crypto currency wallet private key is either an entire or a portion of the crypto currency wallet private key associated with the public key of the crypto currency wallet. In some embodiments, the EDN further comprises extra data that is encrypted along with data associated with the digital note. In some embodiments, the extra data comprises a predetermined physical address or a predetermined proper name.

According to some embodiments of the present disclosure method of generating digital notes includes receiving a first request for generating a digital note with a crypto currency wallet having a crypto currency amount associated with the digital note and generating a crypto currency wallet address and a crypto currency wallet private key associated with the crypto currency wallet address for the crypto currency wallet associated with the digital note. The method further includes returning, in response to the first request, the crypto currency wallet address along with a second request for depositing the crypto currency amount in the crypto currency wallet and verifying the crypto currency amount is deposited in the crypto currency wallet. The method also includes generating a note ID associated with the digital note and generating the digital note that comprises the note ID, the crypto currency wallet address, the crypto currency amount, and an encrypted digital note (EDN) and returning the EDN.

In some embodiments, the method further includes storing the note ID in a list of valid IDs. In some embodiments, the method further includes encrypting a combination of the note ID, the crypto currency wallet address, and the crypto currency amount to generate the EDN. In some embodiments, the EDN further includes either the crypto currency wallet private key or a portion of the crypto currency wallet private key. In some embodiments, the crypto currency wallet address is a public key of the crypto currency wallet associated with the digital note. In some embodiments, the crypto currency wallet private key is associated with the public key of the crypto currency wallet. In some embodiments, the method further includes encrypting a combination of the note ID, the crypto currency wallet address, the crypto currency amount, and extra date to generate the EDN. In some embodiments, the EDN further includes extra data that is encrypted along with data associated with the digital note and the extra data includes a predetermined physical address, a predetermined quote, or a predetermined proper name.

According to some embodiments of the present disclosure, a method of transferring digital notes includes receiving a transfer request and a first encrypted digital note (EDN) associated with a first digital note that comprises a first crypto currency wallet. The method also includes generating a second EDN based on the first EDN and generating a transfer note based on the second EDN. The method also includes returning the transfer note in response to the transfer request.

In some embodiments, the generating the second EDN based on the first EDN includes extracting a first note ID, a first crypto currency wallet address, a first crypto currency amount, and a first crypto currency wallet private key of the first EDN, generating a second note ID, and generating the transfer note based on the second note ID, the first crypto currency wallet address, the first crypto currency amount, and the first crypto currency wallet private key. In some embodiments, the generating the transfer note further includes removing the first note ID from a list of valid IDs and storing the second note ID in the list of the valid IDs. In some embodiments, the generating the transfer note further includes encrypting a combination of the second note ID, the first crypto currency wallet address, the first crypto currency amount, and the first crypto currency wallet private key to generate the transfer note. In some embodiments, the method further includes receiving the transfer note and generating a second digital note that includes the second note ID, the first crypto currency wallet address, the first crypto currency amount, and the second EDN. In some embodiments, the method further includes returning the second EDN.

According to some embodiments of the present disclosure, a method of generating digital collaterals, includes receiving a request for generating a digital collateral with a collateral wallet having a predetermined collateral amount associated with the digital collateral and generating a collateral serial number and a collateral private key associated with the collateral serial number for the collateral wallet associated with the digital collateral. The method also includes verifying the predetermined collateral amount is deposited in the collateral wallet and generating a collateral ID associated with the digital collateral. The method further includes generating the digital collateral that includes the collateral ID, the collateral serial number, the predetermined collateral amount, and an encrypted digital collateral (EDC) and returning the EDC.

In some embodiments, the method further includes storing the collateral ID in a list of valid IDs. In some embodiments, the method further includes encrypting a combination of the collateral ID, the collateral serial number, and the predetermined collateral amount to generate the EDC. In some embodiments, the EDC further includes either the collateral private key or a portion of the collateral private key. In some embodiments, the collateral serial number is a public key of the collateral wallet associated with the digital collateral. In some embodiments, the collateral private key is associated with the collateral serial number of the collateral wallet.

According to some embodiments of the present disclosure, a method of generating digital collaterals by a processor, includes receiving a request for a first encrypted digital collateral (EDC). The method also includes in response to receiving the request, retrieve the first EDC. The method further includes generating a digital collateral ID associated with the first EDC and returning the first EDC.

In some embodiments, the first EDC is retrieved from a storage memory associated with the processor. In some embodiments, the first EDC is retrieved from an external source in communication with the processor.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of transferring digital notes, comprising:
receiving a transfer request and a first encrypted digital note (EDN) associated with a first digital note that comprises a first crypto currency wallet;
generating a second EDN based on the first EDN;
generating a transfer note based on the second EDN; and
returning the transfer note in response to the transfer request.

2. The method of claim 1, wherein by returning the transfer note, the first crypto currency wallet is configured to be transferred.

3. The method of claim 1, wherein the generating the second EDN based on the first EDN comprises:
extracting: a first note ID of the first EDN, a first crypto currency wallet address of the first crypto currency wallet, a first crypto currency amount of the first crypto currency wallet, and a first crypto currency wallet private key of the first crypto currency wallet;
generating a second note ID; and
generating the second EDN using the second note ID, the first crypto currency wallet address of the first crypto currency wallet, the first crypto currency amount of the first crypto currency wallet, and the first crypto currency wallet private key of the first crypto currency wallet.

4. The method of claim 2, wherein the first crypto currency wallet address is a first crypto currency wallet public key of the first crypto currency wallet.

5. The method of claim 2, wherein the generating the transfer note based on the second EDN comprises:
generating the transfer note using the second note ID, the first crypto currency wallet address of the first crypto currency wallet, and the first crypto currency amount of the first crypto currency wallet.

6. The method of claim 2, wherein the generating the transfer note based on the second EDN further comprises:
removing the first note ID from a list of valid IDs; and
storing the second note ID in the list of the valid IDs.

7. The method of claim 2, wherein the generating the transfer note based on the second EDN further comprises:
encrypting a combination of the second note ID, the first crypto currency wallet address of the first crypto currency wallet, and the first crypto currency amount of the first crypto currency wallet to generate the transfer note.

8. The method of claim 6, where the transfer note further comprises:
an encrypted first private key of the first crypto currency wallet.

9. The method of claim 1, wherein the first digital note comprises: the first note ID, the first crypto currency wallet address, the first crypto currency amount, and the first EDN.

10. The method of claim 1, wherein the first EDN comprises an encryption of the: first note ID, the first crypto currency wallet address, the first crypto currency private key, and the first crypto currency amount.

11. The method of claim 1, wherein the second EDN comprises an encryption of the: second note ID, the first crypto currency wallet address, the first crypto currency private key, and the first crypto currency amount.

12. The method of claim 10, further comprising:
generating the second digital note that comprises: the second note ID, the first crypto currency wallet address, the first crypto currency amount, and the second EDN.

13. The method of claim 2, wherein in response to the transfer request the second EDN is returned.

14. The method of claim 2, wherein the first or the second digital note is generated by a first server and is transferred by a separate second server via a transfer note.

15. The method of claim 2, wherein an entire crypto currency wallet private key is stored in the first digital note.

16. The method of claim 2, wherein a portion of the crypto currency wallet private key is stored in the first digital note.

17. The method of claim 2, wherein and the public key and the private key of the crypto currency wallet are stored in a computer module associated a digital note server.

18. The method of claim 16, wherein the crypto currency wallet public key and the crypto currency wallet private key are generated by the digital note server and are stored in a storage memory of the digital note server.

19. The method of claim 5, wherein the list of valid IDs is stored in a storage memory of a computer module.

20. A method of transferring digital notes, comprising:
receiving a transfer request;
receiving a encrypted digital note (EDN) that comprises a crypto currency wallet;
generating a second EDN based on the first EDN;
generating a transfer note based on the second EDN; and
in response to the transfer request, sending the transfer note, wherein by sending the transfer note, the crypto currency wallet is configured to be transferred.
